(19) United States
(12) Patent Application Publication
(10) Pub. No.: US 2025/0385563 A1
(43) Pub. Date: Dec. 18, 2025

(54) END-SHIELD FOR A ROTATING ELECTRIC MACHINE OF A VEHICLE

(71) Applicant: Valeo eAutomotive Germany GmbH, Erlangen (DE)

(72) Inventors: Paul FROGER, Etaples-sur-Mer (FR); Céline CUCHEVAL, Etaples-sur-Mer (FR); Ludovic DOFFE, Etaples-sur-Mer (FR); Mathilde POMMIER, Etaples-sur-Mer (FR); Vincent MOURET, Etaples-sur-Mer (FR); Ruthraapathi KRISHNARAJAN, Etaples-sur-Mer (FR); Daniel BOUCLET, Etaples-sur-Mer (FR)

(73) Assignee: Valeo eAutomotive Germany GmbH, Erlangen (DE)

(21) Appl. No.: 19/240,938

(22) Filed: Jun. 17, 2025

(30) Foreign Application Priority Data
Jun. 18, 2024 (FR) FR2406507

(51) Int. Cl. H02K 5/15; F02N 11/04; H02K 15/144

(52) U.S. Cl. CPC H02K 5/15; H02K 15/144; F02N 11/04

(57) ABSTRACT

An end-shield for a rotating electric machine of a vehicle including a first end-shield half and a second end-shield half mechanically connected to each other by fixing means and defining an internal volume configured to house a rotor/stator assembly. The first end-shield half being intended to support at least one tensioner configured to tension a belt of the vehicle. The end-shield includes a load-spreading member extending between the first end-shield half and the second end-shield half. The load-spreading member is configured to partially transmit a force exerted by the tensioner on the first end-shield half to the second end-shield half. The load-spreading member is distinct from the fixing means.

The present invention relates to the field of rotating electric machines for automotive vehicles, and more particularly relates to an end-shield for such rotating electric machines.

In the automotive field, rotating electric machines are commonly used as a starter-alternator and as such interact with the combustion engine of said vehicle. The starter-alternator, via a belt connecting the rotating electric machine to the crankshaft of the internal combustion engine, performs on the one hand a function of starting the internal combustion engine, when the vehicle is stationary, and on the other hand performs an alternator function when the vehicle is running, this consisting in recovering the mechanical energy of the combustion engine in order to generate electrical energy making it possible for example to power any electric element of the vehicle.

It is known practice for the rotating electric machine to be housed within an end-shield providing the mechanical protection thereof and furthermore allowing the rotating electric machine to be mechanically fixed within an engine assembly.

In addition, to prevent the belt from becoming dislodged from pulleys associated with the driveshafts of the rotating electric machine and the combustion engine due to lack of belt tension, it is known practice to fit tensioners which press against the belt in order to tension the latter as much as possible and to hold it firmly in place. To do this, the tensioners need to be mechanically strong so that they remain in place despite the mechanical force exerted by the belt, including when the belt is in motion. The tensioners are generally fixed to the end-shield of the rotating electric machine.

A mechanical problem arises when the rotating electric machine is applied to a vehicle requiring more power, for example an off-road vehicle. The belt of such a vehicle is more robust, for example because of its larger size, and thus applies a much higher mechanical force, requiring the use of tensioners which likewise have greater mechanical strength. Since the tensioners are fixed to the end-shield, the end-shield also experiences much greater mechanical stresses and can therefore become damaged by bending or breaking. More particularly, the end-shield of the rotating electric machine comprises two end-shield halves which are fixed to each other and configured to house between them the components of the rotating electric machine, namely in particular a rotor/stator assembly and the electronic components for controlling this assembly. The tensioner or tensioners are fixed to one of these end-shield halves and the loads applied by these tensioners have the effect of separating this end-shield half from the other one, and therefore of weakening the fixing means provided for fixing the end-shield halves together.

The present invention falls within this context and proposes for this purpose an end-shield for a rotating electric machine of a vehicle comprising a first end-shield half and a second end-shield half mechanically connected to each other by fixing means and defining an internal volume configured to house a rotor/stator assembly, the first end-shield half being intended to support at least one tensioner configured to tension a belt of the vehicle, characterized in that the end-shield comprises a load-transmission zone in which a load-spreading member extends between the first end-shield half and the second end-shield half, the load-spreading member being configured to partially transmit a force exerted by the tensioner on the first end-shield half to the second end-shield half, the load-spreading member being distinct from the fixing means.

Thanks to the load-transmission zone specifically provided within the end-shield as a whole, the mechanical stresses exerted by at least one of the tensioners during operation of the vehicle are much less concentrated on a specific region of the end-shield and this prevents damage to the end-shield in this region.

The end-shield is used to house a rotor and a stator of the rotating electric machine, which can have a starter-alternator function. In the starter function, the stator is supplied with electrical power so as to cause rotation of the rotor which then drives a driveshaft of the rotating electric machine and then the belt of the vehicle so as to start the combustion engine of the vehicle. Conversely, when the vehicle is running, the alternator function consists in recovering the mechanical energy of the combustion engine so as to generate electrical energy making it possible for example to power any electric element of the vehicle.

The end-shield is divided into two end-shield halves which are assembled together by the fixing means, which may for example be a screw/nut assembly or a rivet, once the rotor and the stator have been housed in the end-shield halves. The end-shield can then be fixed to another element of the rotating electric machine in order to give the rotor/stator assembly and the driveshaft a defined theoretical position in relation to the input/output shaft of the combustion engine.

The first end-shield half corresponds to the end-shield half through which the driveshaft protrudes to interact with the belt. It is therefore on this end-shield half, and more particularly on the external face thereof, that the tensioners are fixed. Thus, at least one of the tensioners exerts a direct mechanical stress on the first end-shield half, which stress tends to move this first end-shield half away from the second end-shield half.

The load-spreading member extends between the two end-shield halves just like the fixing means, but it is important to note that the load-spreading member does not form part of the fixing means.

Thanks to the load-spreading member, which transmits some of the load to the second end-shield half, this mechanical stress is spread between the first end-shield half and the second end-shield half. In this way, the first end-shield half is pulled away from the second end-shield half less forcibly and the second end-shield half is also pulled towards the first end-shield half. The end-shield thus more effectively resists the force exerted by one or more tensioners since the end-shield halves do not tend to move apart from each other, and this notably has the effect of exerting less stress on the fixing means.

According to one feature of the invention, the load-transmission zone, within which the load-spreading member extends, is formed in the vicinity of a zone of the first end-shield half intended for fixing a tensioner.

According to one feature of the invention, each end-shield half comprises at least one connecting orifice centred about a connection axis, each connecting orifice facing each other, the load-spreading member comprising an internally-threaded bush mounted in the connecting orifice of the second end-shield half and a threaded screw passing through the connecting orifice of the first end-shield half and cooperating with the internal thread of the bush. Each connecting orifice is disposed in the load-transmission zone, and the orifices may notably be disposed substantially in the centre of this zone. It may be considered that each end-shield half comprises a load-transmission zone of its own, with a connecting orifice arranged in this zone, and that the assembly of the two end-shield halves and of their load-transmission zone form a load-transmission zone of the end-shield as a whole, and through which the load-transmission member passes. The threaded screw and the bush thus contribute to generating a mechanical link between the two end-shield halves, without participating in the assembly to form the end-shield. In other words, at rest, that is to say when the belt is not in motion, little load is applied to this load-spreading member. The load-spreading member is distinctive here in that the cooperation of the screw with the bush allows the bush to be made to move within the connecting orifice of the second end-shield half to ensure that this bush is in contact with the first end-shield half when the vehicle is running, this being in a zone not provided with fixing means.

Thus, when the tensioner applies mechanical stresses to the first end-shield half to which it is fixed, loads are transmitted from the first end-shield half to the second end-shield half at least partially via the bush and that portion of this bush that is in contact with the first end-shield half.

The loads transmitted through the bush are then transmitted to the second end-shield half which thus absorbs some of the mechanical stress applied by the tensioner. The fact that loads pass through the bush directly in contact with the first end-shield half makes it possible not to stress the screw in this load-transmission zone, which is provided in addition to the fixing zones.

The connecting orifices of each end-shield half need to be aligned with each other so that the threaded screw can be inserted through each of the connecting orifices centred on the connection axis. The internally-threaded bush is inserted into the connecting orifice of the second end-shield half. Thus, the threaded screw extends inside the internally-threaded bush, which is itself inside the connecting orifice of the second end-shield half.

According to one feature of the invention, the bush comprises a body cooperating with the connecting orifice of the second end-shield half and a head arranged outside the connecting orifice of the second end-shield half and positioned on the opposite side of the second end-shield half from the first end-shield half. It is notable that it is the body of the internally-threaded bush that, on the one hand, is mounted in the connecting orifice and, on the other hand, cooperates with the screw, the head having no function in the transmission of load through the bush.

According to one feature of the invention, at the opposite end from the head, the body has an end portion intended to come into contact with the first end-shield half. It is this contact, made possible by the tight sliding fit of the body of the bush within the connecting orifice of the second end-shield half and by the adjustment of the position of the bush by cooperation with the screw, that makes it possible to form a bridge for absorbing load and transmitting some of the load experienced by the first end-shield half to the second end-shield half.

According to one feature of the invention, the second end-shield half comprises anti-rotation means preventing the head of the bush rotating. These anti-rotation means make it possible to prevent the bush from being made to rotate in the connecting orifice of the second end-shield half, when the load-spreading member is being mounted on the end-shield. It is thus possible to screw the threaded screw into the bush which is blocked against rotation.

According to one example, the anti-rotation means may be a rib formed on the second end-shield half and extending across the passage in which the head of the bush would rotate. One or more ribs may generate an assembly of shape complementary to the shape of the head of the bush. The bush is thus blocked in at least one direction of rotation.

According to one feature of the invention, in the load-transmission zone, the first end-shield half comprises a first face facing the second end-shield half, the body of the bush being intended to be in direct contact with the first face of the first end-shield half. During assembly of the load-spreading member, the body of the bush emerges from the connecting orifice of the second end-shield half to come into contact with the first face of the first end-shield half.

According to one feature of the invention, a length of the body of the bush is greater than a distance between the first face of the first end-shield half and a first face of the second end-shield half facing away from the first end-shield half. In other words, the body of the bush is longer than the sum of the thickness of the second end-shield half and a clearance zone, i.e. the distance between the end-shield halves in the load-transmission zone when the two end-shield halves are fixed together. This ensures, during assembly, that the body of the bush is in contact with the first face of the first end-shield half before the head of the bush comes into contact with the first face of the second end-shield half, it being understood that this would prevent the spreading of the load as desired according to the invention and would carry the risk of causing the first end-shield half to bend.

According to one feature of the invention, the bush and the connecting orifice of the second end-shield half are dimensioned to allow a degree of freedom of translation for the bush within the connecting orifice of the second end-shield half in a direction parallel to the connection axis. In other words, the bush and the connecting orifice of the second end-shield half are configured, notably in terms of surface roughness, so that between them they form a tight sliding fit, which ensures that the bush is clamped in the connecting orifice to the micron, while allowing a degree of freedom of translation as mentioned above, when, during assembly of the load-spreading member, the bush moves within the connecting orifice of the second end-shield half to come into contact with the first face of the first end-shield half.

According to one feature of the invention, the bush comprises a zinc-nickel alloy coating. This coating is suitable for producing a tight sliding fit within the connecting orifice of the second end-shield half. It also offers corrosion resistance.

According to one feature of the invention, the first end-shield half comprises a radial protuberance bearing at least one connecting orifice for connecting the tensioner, and the connecting orifice of the first end-shield half. The radial protuberance contributes to forming the load-transmission zone of the first end-shield half, allowing the first end-shield half to be extended in order to ensure that there is space for incorporating the two above-mentioned orifices. Since the tensioner connecting orifice and the connecting orifice of the first end-shield half are close to each other, the load generated by the tensioner can be absorbed more effectively by the load-spreading member.

The invention also covers a rotating electric machine for a vehicle, comprising a rotor/stator assembly having at least a rotor and a stator, and an end-shield as described above housing the rotor/stator assembly. As mentioned earlier, the rotor drives a driveshaft that interacts with the belt by driving it in motion. At least one tensioner presses against the belt and is fixed to the end-shield. According to the invention, the latter comprises load-transmission means and is thus configured to withstand the mechanical stresses applied by the tensioner.

The invention also covers a method for mounting an end-shield as described above, comprising:
a step of fixing the end-shield halves together by an operation of tightening the fixing means, bringing, in a load-transmission zone, the first end-shield half to a predetermined distance from the second end-shield half and positioning the connecting orifice of each end-shield half facing each other,
a step of positioning the load-spreading member through the connecting orifices, the positioning step being subsequent to the fixing step.

The end-shield is first assembled via the fixing means so that the load-spreading member can be installed afterwards. In this way, it will be understood that the load-spreading member is distinct from the fixing means and that the positioning of the end-shield halves relative to each other is ensured by tightening the fixing means. The function of the load-spreading member is, in a second stage, merely to ensure local contact between the first end-shield half and the second end-shield half via the movable bush of this load-spreading member, in a zone in which the end-shield halves are not intended to be pressed against each other by the fixing means.

According to one feature of the method, the positioning step comprises:
a step of fitting the bush inside the connecting orifice of the second end-shield half,
a step of fitting the screw through the connecting orifices and through the bush,
a step of screwing the screw inside the bush so as to move the bush axially within the connecting orifice of the second end-shield half until the bush is in contact with the first end-shield half.

In this way, the screw makes it possible to bring the bush closer by virtue of the anti-rotation means preventing the head of the bush from rotating in phase with the rotation of the screw. The step of fitting the bush is carried out in such a way as to generate a tight sliding fit within the connecting orifice of the second end-shield half. The degree of freedom in translation of the bush makes it possible to bring the latter closer until it comes into contact with the first end-shield half, while ensuring tight contact of the bush with the wall delimiting the connecting orifice within the second end-shield half.

Other features and advantages of the invention will become more clearly apparent both from the following description and from a number of exemplary embodiments provided by way of non-limiting indication with reference to the appended schematic drawings, in which:

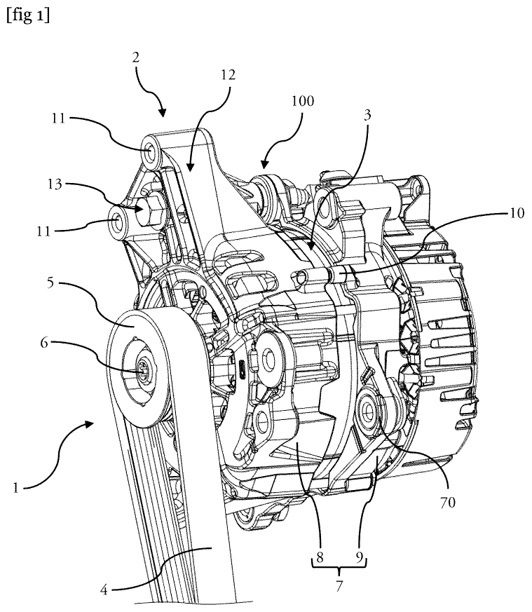

FIG. 1 is a partial depiction of an engine assembly comprising a rotating electric machine provided with an end-shield according to the invention,

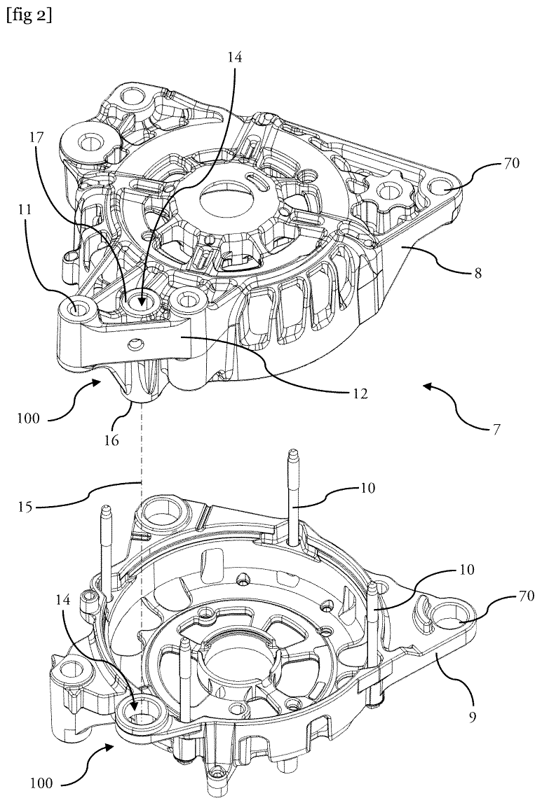

FIG. 2 is an exploded view of two end-shield halves that make up the end-shield according to the invention,

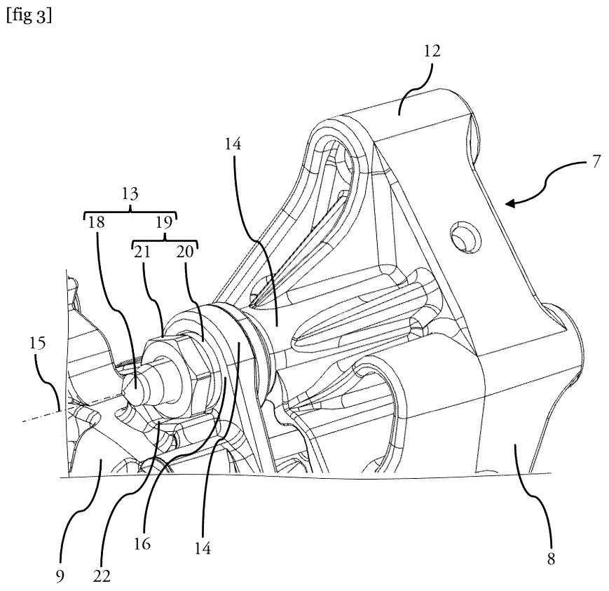

FIG. 3 is a view of a load-spreading member incorporated into the end-shield,

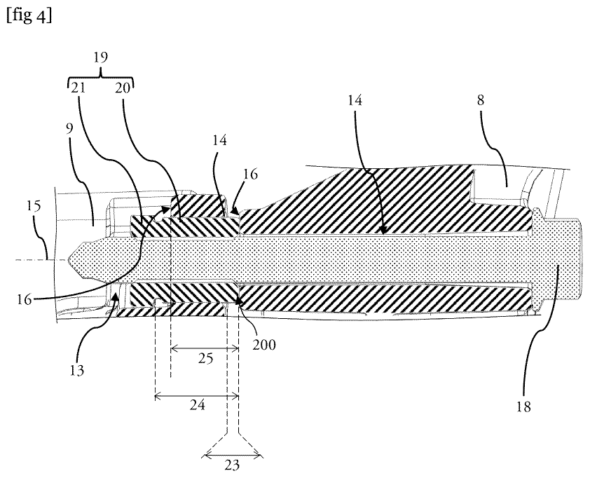

FIG. 4 is a sectioned view of the load-spreading member within the end-shield.

FIG. 1 is a partial depiction of an engine assembly 1 that can be incorporated into an automotive vehicle. The engine assembly 1 comprises a rotating electric machine 2 and a combustion engine, not depicted here. The rotating electric machine 2 comprises a rotor/stator assembly 3 connected to a belt 4 which, in a manner not illustrated, is also connected to a crankshaft of the combustion engine. The rotating electric machine 2 is thus capable of interacting with the combustion engine by means of the belt 4.

Here, the rotating electric machine 2 acts as a starter-alternator, capable of performing both a function of assisting the starting of the automotive vehicle and an electrical energy recovery function. When the vehicle is started, a rotor of the rotor/stator assembly 3 is set in rotation, via its magnetic elements and for example permanent magnets, by a magnetic field created as a result of the supply of electricity to a winding of the stator, the rotation of the rotor then driving a pulley 5 arranged at the end of a driveshaft 6 secured to the rotor and around which the belt 4 is arranged, then making it possible to drive the combustion engine. Conversely, when the vehicle is running, the combustion engine drives the movement of the belt 4, which in turn rotates the rotor, via the pulley 5, and the rotor/stator interaction and the electronic components associated with the winding of the stator make it possible to convert mechanical energy into electrical energy.

The rotor/stator assembly 3 of the rotating electric machine 2 is housed in an end-shield 7. The latter performs the function of protecting and mechanically holding the rotor/stator assembly 3. Only the pulley 5 associated with the rotor extends outside the end-shield 7 so that the movement can be transmitted from the rotor to the belt 4 or vice versa.

As illustrated in FIG. 1, the end-shield 7 is divided into a first end-shield half 8 and a second end-shield half 9 mechanically connected to each other by a plurality of fixing means 10. The first end-shield half 8 and the second end-shield half 9 delimit an internal volume housing the rotor/stator assembly 3. Once the latter has been positioned, the fixing means 10 are used to connect the end-shield halves 8, 9 together and thus lock the end-shield 7 and provide protection and mechanical retention for the rotor/stator assembly 3. The end-shield 7 also comprises fixing members 70 which allow the rotating electric machine to be fixed to the engine assembly.

In a manner not illustrated, the engine assembly 1 comprises at least one tensioner ensuring that the belt 4 is tensioned so that it does not become dislodged from the pulley 5. Such a tensioner may be fixed to the first end-shield half 8 by means of connecting orifices 11, here disposed on a radial protuberance 12 formed at the first end-shield half 8.

The tensioner makes it possible to apply pressure to the belt 4 and thus has a high mechanical strength to withstand a force exerted by the belt 4, particularly when the latter is in motion, and the tensioner can exert high levels of stress on the first end-shield half 8, in particular if the associated belt is of large size, for example if the engine assembly 1 is an off-road vehicle engine assembly. The stresses exerted by the tensioner have the effect of moving the first end-shield half 8 away from the second end-shield half 9, and this has the notable effect of stressing and weakening the fixing means.

According to the invention, means are implemented to counteract the tensioner load exerted on the first end-shield half 8 at the radial protuberance 12.

Thus, the end-shield 7 according to the invention comprises a load-transmission zone 100, disposed in this instance at the radial protuberance 12, within which a load-spreading member 13 extends between the first end-shield half 8 and the second end-shield half 9. The load-spreading member 13 is mechanically connected, while nevertheless being distinct from the fixing means 10, to the first end-shield half 8 and to the second end-shield half 9, in this instance at the radial protuberance 12, close to the connecting orifice 11.

Unlike the purpose of the fixing means 10, the purpose of the load-spreading member 13 is not to fix the position of one end-shield half with respect to the other, but rather to generate contact between the two end-shield halves in a zone close to the connecting orifice 11 in order to absorb the load and thus spread the mechanical load applied by the tensioner to the first end-shield half 8 by partially transmitting it to the second end-shield half 9. This makes it possible to avoid concentrating the mechanical load on one zone of the end-shield 7 in particular and thus greatly limits the risk of damaging the latter.

FIG. 2 is a depiction of the end-shield 7 according to the invention with the first end-shield half 8 and the second end-shield half 9 separated from each other. As mentioned above, the end-shield 7 is able to delimit an internal volume capable of containing the rotor/stator assembly, not visible here.

In FIG. 2, there are four of the fixing means 10, ensuring uniform fixing of the end-shield halves 8, 9 to one another. The fixing means 10 in this instance are screws, which need to cooperate with nuts, not depicted here, and which enable the end-shield halves to be pressed firmly against each other. Of course, any other type of fixing means 10 can be envisaged.

Once the two end-shield halves 8, 9 have been assembled via an operation of tightening the fixing means 10, the two end-shield halves are pressed firmly against each other at least in the fixing zone. Fixing-member orifices 70 extend at the periphery of each of the end-shield halves so as to face each other and to enable the end-shield to be mechanically connected to another element of the engine assembly.

In the load-transmission zone 100, it may be noted, particularly in FIG. 4, that the first end-shield half 8 and the second end-shield half 9 are arranged at a predetermined distance from each other, with a clearance zone 23.

In this load-transmission zone 100, each end-shield half comprises a connecting orifice 14 facing each other. It is through these connecting orifices 14 that the load-spreading member 13 illustrated in FIG. 1 extends.

The connecting orifices 14 of each end-shield half 8, 9 are both centred on the same connection axis 15, and are through-holes, that is to say holes opening out at each end onto a face of the corresponding end-shield half.

Each end-shield half comprises, in this load-transmission zone 100, a first face 16 and a second face 17, these being substantially perpendicular to the common connection axis 15. Thus, the first face 16 of the first end-shield half 8 corresponds to the face facing the second end-shield half 9 once the end-shield 7 has been assembled, while the first face 16 of the second end-shield half 9 corresponds to the face facing away from the first end-shield half 8 once the end-shield 7 has been assembled. The first face 16 of the first end-shield half 8 and the second face 17 of the second end-shield half 9 therefore face one another.

Once the end-shield halves 8, 9 have been fixed together, the load-spreading member 13 is then installed as illustrated in FIGS. 3 and 4. FIG. 3 reveals that the load-spreading member 13 is made up of a threaded screw 18 passing through the connecting orifice 14 of each of the end-shield halves 8, 9, and of an internally-threaded bush 19 which locks the position of the screw 18. The load-spreading member 13 is configured to enable an operator to create contact between the end-shield halves in the load-spreading zone, via the bush which is moved appropriately, to a position in which the end-shield halves are not initially in contact with each other. Thus, during operation of the vehicle, with the bush forming a load-absorbing bridge, some of the mechanical stress applied by the tensioner or tensioners to the first end-shield half 8 is transmitted via the bush 19 towards the second end-shield half 9.

The bush 19 is made up of a body 20 and of a head 21. The body 20 of the bush 19 has a portion housed within the connecting orifice 14 of the second end-shield half 9 and an end portion 200, at the opposite end from the head 21, which is positioned in the clearance zone 23 formed between the two end-shield halves in the load-spreading zone 100. The head 21 is outside the connecting orifice 14 of the second end-shield half 9, on the opposite side from the first end-shield half 8, and is intended to cooperate with anti-rotation means 22.

More particularly, the anti-rotation means 22 may take the form of a simple rib which blocks the rotation of the head by generating an abutment surface across the rotation path, or else take the form of a set of ribs of a shape at least partially complementary to the shape, in particular hexagonal, of the head 21 of the bush 19 as illustrated in FIG. 3. The head 21 is thus blocked and cannot perform any rotational movement, which allows the load-spreading member 13 to be mounted during a positioning step of positioning the latter through the connecting orifice 14 of each end-shield half 8, 9.

As will be described below, in this configuration, the rotation-blocking of the head 21 of the bush enables the screw 18 to be positioned in one translational direction and then, in a second stage, once the screw is in position, allows the bush 19 to be moved in the opposite translational direction until the body of the bush, and more particularly the end portion 200 of this body 20, comes into contact with the first end-shield half 8.

Preferably, the bush 19 is made with a zinc-nickel alloy coating. It is notable that this coating allows the bush 19 to be mounted within the connecting orifice of the second end-shield half 9 as a tight sliding fit, i.e. with the outside diameter of the bush body matching the inside diameter of the connecting orifice to within one micron, so that only a translational movement along the axis of elongation of the connecting orifice, in this instance the connection axis 15, is permitted.

Other features of the load-spreading member 13 will be mentioned in a more detailed description of the method for assembling an end-shield according to the invention, which makes it possible to arrive at the installation of the load-spreading member 13 carried out as illustrated in the sectional view of FIG. 4. FIG. 4 clearly illustrates that the body 20 of the bush 19 is partially disposed within the connecting orifice 14 of the second end-shield half 9, with a free end, at the opposite end from the head 21, which is in contact with the first end-shield half 8. The screw 18 is thus in position after having interacted with the bush 19 and not with the connecting orifice 14 of the second end-shield half 9 directly.

During a method for mounting the end-shield, and after a step of fixing the end-shield halves 8, 9 to one another, the above-mentioned step of positioning the load-spreading member 13 is performed. If the bush 19 is not already fitted within the connecting orifice 14 of the second end-shield half 9 before the step of fixing the end-shield halves 8, 9 together, the positioning step begins with mounting the bush 19 within the connecting orifice 14 of the second end-shield half 9. However, advantageously, the positioning step can begin before the fixing step, and the bush 19 is positioned within the connecting orifice 14 of the second end-shield half 9 before the fixing step.

Once this has been done, the screw 18 is positioned through the connecting orifices 14 and a screwing step is performed. The result of this screwing step is a movement of the bush which makes it possible to ensure, in the load-transmission zone, far-removed from the fixing zones, that the two end-shield halves are brought into contact via this bush so that load can be absorbed.

The two end-shield halves are fixed together via the fixing means 10 once the rotor/stator assembly has been inserted into the housing formed between these two end-shield halves. As mentioned, this results, in a load-transmission zone 100 visible in FIGS. 3 and 4, in there being a clearance zone 23 between a first face of the first end-shield half 8 and a second face of the second end-shield half 9. Furthermore, in this position, the connecting orifices 14 of the end-shield halves are aligned and the screw 18 can be inserted through these two connecting orifices.

Beforehand, in a positioning step, the bush 19 is mounted in the connecting orifice 14 of the second end-shield half 9, as a tight sliding fit, allowing only a translation along the axis of elongation of this connecting orifice, in this instance the connection axis 15. The bush is inserted with the head 21 of the bush which is on the same side as the first face of the second end-shield half 9, in cooperation with the anti-rotation means 22.

The screw 18 is then inserted into the connecting orifices so as to cooperate with the internal thread of the bush. The head 21 of the bush 19 is blocked in at least one direction of rotation, allowing the screw 18 to be screwed into the internal thread of the body 20 of the bush 19 without the rotation of the latter.

The screwing of the screw 18 into the internal thread of the bush 19 continues until the screw 18 is in the final position, as shown in FIG. 4, with the screw head abutting against the first end-shield half 8 in a direction parallel to the connection axis 15. Once the final position of the screw has been reached, the screwing of the screw 18 into the internal thread of the bush, the head of which is prevented from rotating, has the effect of causing the bush to move axially towards the screw head, and therefore towards the first end-shield half 8. This translational movement is rendered possible by the tight sliding fit between the bush and the second end-shield half 9. The bush 19 therefore moves towards the first end-shield half 8 until it is in direct contact, via the end portion 200 of the body 20 of the bush, with the first face 16 of the first end-shield half 8. The translational movement of the bush 19 takes place over an axial distance substantially equal to the clearance zone 23.

If necessary, a nut is fitted on the free end of the shank to prevent gradual disengagement of the screw 18 as a result of vibrations when the vehicle is in operation.

The features of the bush 19 are such that a length 24 of the body 20 of the bush 19 is greater than a distance 25 between the first face 16 of the first end-shield half 8 and the first face 16 of the second end-shield half 9, said distance 25 being measured after the end-shield halves 8, 9 have been fixed together. In this way, during the mounting of the load-spreading member 13, the bush 19 comes into contact with the first face 16 of the first end-shield half 8, without the head 21 of the bush first encountering the first face 16 of the second end-shield and preventing the end portion 200 of the body 20 of the bush from coming into contact with the first end-shield half 8.

It is mainly this configuration of the load-transmission zone 100, with the contact between the first end-shield half 8 and the bush, which is mounted as a tight sliding fit in the second end-shield half 9, which allows the transmission of the load experienced by the first end-shield half 8 as a result of the tensioners fixed to this first end-shield half. It is particularly advantageous according to the invention to use the load-spreading member 13 in order to be able to create this load-transmission bridge in a load-transmission zone 100, without having to act upon the means employed for fixing the end-shield halves to one another and without having to act upon the direct distance between the end-shield halves 8, 9.

The invention, as has just been described, achieves the objectives it had set for itself, and makes it possible to offer an end-shield resistant to the mechanical stresses applied by a belt tensioner by spreading said stresses over each of the end-shield halves contributing to forming this end-shield. Variants that are not described herein can be implemented without departing from the context of the invention, provided that, in accordance with the invention, they comprise an end-shield according to the invention.

1. End-shield for a rotating electric machine of a vehicle comprising a first end-shield half and a second end-shield half mechanically connected to each other by fixing means and defining an internal volume configured to house a rotor/stator assembly, the first end-shield half being intended to support at least one tensioner configured to tension a belt of the vehicle, wherein the end-shield comprises a load-transmission zone in which a load-spreading member extends between the first end-shield half and the second end-shield half, the load-spreading member being configured to partially transmit a force exerted by the tensioner on the first end-shield half to the second end-shield half, the load-spreading member being distinct from the fixing means.

2. End-shield according to claim 1, wherein each end-shield half comprises at least one connecting orifice centred about a connection axis, each connecting orifice facing each other, the load-spreading member comprising an internally-threaded bush mounted in the connecting orifice of the second end-shield half and a threaded screw passing through the connecting orifice of the first end-shield half and cooperating with the internal thread of the bush.

3. End-shield according to claim 2, wherein the bush comprises a body cooperating with the connecting orifice of the second end-shield half and a head arranged outside the connecting orifice of the second end-shield half and positioned on the opposite side of the second end-shield half from the first end-shield half.

4. End-shield according to claim 3, wherein the second end-shield half comprises anti-rotation means preventing the head of the bush rotating.

5. End-shield according to claim 3, wherein, in the load-transmission zone, the first end-shield half comprises a first face facing the second end-shield half, the body of the bush being intended to be in direct contact with the first face of the first end-shield half.

6. End-shield according to claim 5, wherein a length of the body of the bush is greater than a distance between the first face of the first end-shield half and a first face of the second end-shield half facing away from the first end-shield half.

7. End-shield according to claim 2, wherein the bush and the connecting orifice of the second end-shield half are dimensioned to allow a degree of freedom of translation for the bush within the connecting orifice of the second end-shield half in a direction parallel to the connection axis.

8. End-shield according to claim 2, wherein the bush comprises a zinc-nickel alloy coating.

9. End-shield according to claim 2, wherein the first end-shield half comprises a radial protuberance bearing at least one connecting orifice for connecting the tensioner, and the connecting orifice of the first end-shield half.

10. Rotating electric machine for a vehicle, comprising a rotor/stator assembly having at least a rotor and a stator, and an end-shield according to claim 1 housing the rotor/stator assembly.

11. Method for mounting an end-shield according to claim 2, comprising:
a step of fixing the end-shield halves together by an operation of tightening the fixing means, bringing, in a load-transmission zone, the first end-shield half to a predetermined distance from the second end-shield half and positioning the connecting orifice of each end-shield half facing each other,
a step of positioning the load-spreading member through the connecting orifices, the positioning step being subsequent to the fixing step.

12. Method for mounting according to claim 11 performed on an end-shield for a rotating electric machine of a vehicle comprising a first end-shield half and a second end-shield half mechanically connected to each other by fixing means and defining an internal volume configured to house a rotor/stator assembly, the first end-shield half being intended to support at least one tensioner configured to tension a belt of the vehicle, wherein the end-shield comprises a load-transmission zone in which a load-spreading member extends between the first end-shield half and the second end-shield half, the load-spreading member being configured to partially transmit a force exerted by the tensioner on the first end-shield half to the second end-shield half, the load-spreading member being distinct from the fixing means, wherein each end-shield half comprises at least one connecting orifice centred about a connection axis, each connecting orifice facing each other, the load-spreading member comprising an internally-threaded bush mounted in the connecting orifice of the second end-shield half and a threaded screw passing through the connecting orifice of the first end-shield half and cooperating with the internal thread of the bush, wherein the positioning step comprises:
a step of fitting the bush inside the connecting orifice of the second end-shield half,
a step of fitting the screw through the connecting orifices and through the bush,
a step of screwing the screw inside the bush so as to move the bush axially within the connecting orifice of the second end-shield half until the bush is in contact with the first end-shield half.

13. End-shield according to claim 4, wherein, in the load-transmission zone, the first end-shield half comprises a first face facing the second end-shield half, the body of the bush being intended to be in direct contact with the first face of the first end-shield half.

14. End-shield according to claim 3, wherein the bush and the connecting orifice of the second end-shield half are dimensioned to allow a degree of freedom of translation for the bush within the connecting orifice of the second end-shield half in a direction parallel to the connection axis.

15. End-shield according to claim 3, wherein the bush comprises a zinc-nickel alloy coating.

16. End-shield according to claim 3, wherein the first end-shield half comprises a radial protuberance bearing at least one connecting orifice for connecting the tensioner, and the connecting orifice of the first end-shield half.

17. Rotating electric machine for a vehicle, comprising a rotor/stator assembly having at least a rotor and a stator, and an end-shield according to claim 2 housing the rotor/stator assembly.

18. Method for mounting an end-shield according to claim 3, comprising:
a step of fixing the end-shield halves together by an operation of tightening the fixing means, bringing, in a load-transmission zone, the first end-shield half to a predetermined distance from the second end-shield half and positioning the connecting orifice of each end-shield half facing each other,
a step of positioning the load-spreading member through the connecting orifices, the positioning step being subsequent to the fixing step.

19. End-shield according to claim 4, wherein the bush and the connecting orifice of the second end-shield half are dimensioned to allow a degree of freedom of translation for the bush within the connecting orifice of the second end-shield half in a direction parallel to the connection axis.

20. End-shield according to claim 4, wherein the bush comprises a zinc-nickel alloy coating.
